(19) United States
(12) Patent Application Publication
(10) Pub. No.: US 2026/0054597 A1
(43) Pub. Date: Feb. 26, 2026

(54) SYSTEM AND METHOD FOR OPERATIONAL EFFICIENCY OF EV CHARGING STATIONS IN A BUILDING

(71) Applicant: Honeywell International Inc., Charlotte, NC (US)

(72) Inventors: Ramanjaneyulu Karnati, Palnadu (IN); Madhav Kamath, Bangalore (IN); Rajendra Kumar S, Bangalore (IN)

(21) Appl. No.: 18/814,212

(22) Filed: Aug. 23, 2024

(51) Int. Cl. B60L 53/67; B60L 53/62

(52) U.S. Cl. CPC B60L 53/67; B60L 53/62

(57) ABSTRACT

Systems and methods for determining load reductions applicable to charging stations at a facility. A facility having one or more internal power users and one or more associated charging stations is controlled using a facility controller which determines that a power reduction is desirable. The quantity of power reduction used at the charging stations is selected and a set of calculations occurs to determine how much power reduction each charging station and electric vehicle is subjected to based on the requested quantity of power reduction, the type of charging station and the type of electric vehicle or electric vehicle user.

### BACKGROUND

Electric vehicle adoption is spreading and, in response, charging stations for such vehicles are proliferating. Facilities having charging stations may have multiple charge station types, multiple users for such facilities, and other power demands in the facility. It is desirable to have facilities management control the use of such charging stations with a range of considerations available to ensure operational efficiencies.

### Overview

The present inventors have recognized, among other things, that a problem to be solved is the need for new and/or alternative methods and systems for managing charging systems at a facility.

A first illustrative and non-limiting example takes the form of a facility management system for a facility having one or more internal power users and at least two charging stations each adapted for charging electric vehicles using charging station (CS) power controlled by the facility management system, the two charging stations each classified as either a first CS type or a second CS type, the electric vehicles each classified as either a first user type or a second user type, the facility comprising at least one non-charging station power user, the facility management system including a CS supervisor configured to: deliver power to a first charging station to charge a first electric vehicle; determine the user type for the first electric vehicle and the charge station type for the first charging station; and: if the first electric vehicle is the first user type, monitor at least one of duration of charging relative to a duration threshold, or a power delivered during charging relative to a power threshold, and, upon reaching the duration threshold or the power threshold, the CS supervisor is configured to instruct or cause the first charging station to stop charging the first electric vehicle; and otherwise, the CS supervisor is configured to allow the first electric vehicle, the first charging station, and/or a user of the first electric vehicle to determine when to stop charging the first electric vehicle.

Additionally or alternatively, the CS supervisor is configured to: receive an input indicating CS power to the at least two charging stations is to be reduced by a reduction amount; determine, for each electric vehicle at each charging station, a user type and a CS type, and a first CS power used at each charging station; calculate a second CS power for each charging station based on each of the first CS power, the reduction amount, the user type, and the CS type; and derate power delivered to at least one of the charging stations using the calculated second CS powers such that total power to the at least two charging stations is reduced by the reduction amount.

Additionally or alternatively, the system further comprises a facility controller which is configured to provide the input indicating CS power to the CS supervisor by: observing a current state of the facility, including power used in the facility; and determine a quantity of power reduction applicable to the CS power required from the CS supervisor.

Additionally or alternatively, the CS supervisor is configured to: receive a maximum derating value, and a setback derating value; calculate the second CS power for each charging station as follows: determining a priority of the electric vehicles from 1 to n, wherein n is the number of electric vehicles at charge stations when the calculation is performed and the priority ranks the electric vehicles according to predetermined criteria; starting with the vehicle of the highest priority, calculating a load change and proceeding until a sum of calculated load changes equals the reduction amount, as follows: for a user of the first user type and a charge station of the first CS type, multiplying the first CS power by the maximum derating value to calculate the load change; for a user of the second user type and a charge station of the first CS type, multiplying the first CS power by a difference between the maximum derating value and the setback derating value to calculate the load change; for a user of the first user type and a charge station of the second CS type, multiplying the first CS power by a difference between the maximum derating value and the setback derating value to calculate the load change; for a user of the second user type and a charge station of the second CS type, setting the load change to zero; and calculating the second CS power equal to the first CS power minus the load change.

Additionally or alternatively, the priority ranks the electric vehicles from a highest state of charge (SOC) to lowest SOC. Additionally or alternatively, the priority ranks the electric vehicles from a longest duration of charging to a shortest duration of charging. Additionally or alternatively, the priority ranks the electric vehicles from a largest quantity of power delivered during charging to a least quantity of power delivered during charging.

Additionally or alternatively, the first CS type is a normal charge station, and the second CS type is a reservable charge station, and the first user type is a normal user, and the second user type is a premium user type.

Another illustrative and non-limiting example takes the form of a facility management system for a facility having one or more internal power users and at least two charging stations each adapted for charging electric vehicles using charging station (CS) power controlled by the facility management system, the two charging stations each classified as either a first CS type or a second CS type, the electric vehicles each classified as either a first user type or a second user type, the facility management system comprising at least one non-charging station power user, comprising a CS supervisor configured to: receive an input indicating CS power to the at least two charging stations is to be reduced by a reduction amount; determine, for each electric vehicle at each charging station, a user type and a CS type, and a first CS power used at each charging station; calculate a second CS power for each charging station based on each of the first CS power, the reduction amount, the user type, and the CS type; and derate power delivered to at least one of the charging stations using the calculated second CS powers such that total power to the at least two charging stations is reduced by the reduction amount.

Additionally or alternatively, the system further comprises a facility controller which is configured to provide the input indicating CS power to the CS supervisor by: observing a current state of the facility, including power used in the facility; and determine a quantity of power reduction applicable to the CS power required from the CS supervisor.

Additionally or alternatively, the first CS power for each charging station is determined as an actual power used at each charging station.

Additionally or alternatively, the first CS power for each charging station is calculated as a power request for each charging station.

Additionally or alternatively, the CS supervisor is configured to: receive a maximum derating value, and a setback derating value; calculate the second CS power for each charging station as follows: determining a priority of the electric vehicles from 1 to n, wherein n is the number of electric vehicles at charge stations when the calculation is performed and the priority ranks the electric vehicles according to predetermined criteria; starting with the vehicle of the highest priority, calculating a load change and proceeding until a sum of calculated load changes equals the reduction amount, as follows: for a user of the first user type and a charge station of the first CS type, multiplying the first CS power by the maximum derating value to calculate the load change; for a user of the second user type and a charge station of the first CS type, multiplying the first CS power by a difference between the maximum derating value and the setback derating value to calculate the load change; for a user of the first user type and a charge station of the second CS type, multiplying the first CS power by a difference between the maximum derating value and the setback derating value to calculate the load change; for a user of the second user type and a charge station of the second CS type, setting the load change to zero; and calculating the second CS power equal to the first CS power minus the load change.

Additionally or alternatively, the priority ranks the electric vehicles from a highest state of charge (SOC) to lowest SOC. Additionally or alternatively, the priority ranks the electric vehicles from a longest duration of charging to a shortest duration of charging. Additionally or alternatively, the priority ranks the electric vehicles from a largest quantity of power delivered during charging to a least quantity of power delivered during charging.

Additionally or alternatively, the first CS type is a normal charge station, and the second CS type is a reservable charge station, the first user type is a normal user, and the second user type is a premium user type.

Additionally or alternatively, the CS supervisor is configured to calculate a second CS power for each charging station by determining a priority of the electric vehicles from 1 to n, wherein n is the number of electric vehicles at charge stations when the calculation is performed and the priority ranks the electric vehicles according to predetermined criteria.

Additionally or alternatively, the CS supervisor is configured to derate the power delivered to the at least two charging stations by communicating a maximum allowed power to each of the at least two charging stations.

Another illustrative and non-limiting example takes the form of a non-transitory computer readable medium storing instructions for configuring a controller as described in the preceding examples, including any of the noted additions or alternatives thereto.

Another illustrative and non-limiting example takes the form of a method of managing power delivered to a plurality of charging stations (CS) at a facility comprising: receiving an input indicating CS power to the plurality of CS is to be reduced by a reduction amount; determining, for each electric vehicle at each CS, a user type and a CS type, and a first CS power used at each CS; calculating a second CS power for each CS based on each of the first CS power, the reduction amount, the user type, and the CS type; and derating power delivered to at least one of the CS using the calculated second CS powers such that total power to the plurality of CS is reduced by the reduction amount.

Additionally or alternatively, the method also includes receiving a maximum derating value and a setback derating value; calculating the second CS power for each charging station as follows: determining a priority of the electric vehicles from 1 to n, wherein n is the number of electric vehicles at charge stations when the calculation is performed and the priority ranks the electric vehicles according to predetermined criteria; starting with the vehicle of the highest priority, calculating a load change and proceeding until a sum of calculated load changes equals the reduction amount, as follows: for a user of the first user type and a charge station of the first CS type, multiplying the first CS power by the maximum derating value to calculate the load change; for a user of the second user type and a charge station of the first CS type, multiplying the first CS power by a difference between the maximum derating value and the setback derating value to calculate the load change; for a user of the first user type and a charge station of the second CS type, multiplying the first CS power by a difference between the maximum derating value and the setback derating value to calculate the load change; for a user of the second user type and a charge station of the second CS type, setting the load change to zero; and calculating the second CS power equal to the first CS power minus the load change.

Additionally or alternatively, the first CS type is a normal charge station, and the second CS type is a reservable charge station, the first user type is a normal user, and the second user type is a premium user type.

Additionally or alternatively, the priority ranks the electric vehicles from a highest state of charge (SOC) to lowest SOC. Additionally or alternatively, the priority ranks the electric vehicles from a longest duration of charging to a shortest duration of charging. Additionally or alternatively, the priority ranks the electric vehicles from a largest quantity of power delivered during charging to a least quantity of power delivered during charging.

Another illustrative and non-limiting example takes the form of a non-transitory computer readable medium storing instructions for performing the methods just described, including any of the noted additions or alternatives thereto.

This overview is intended to provide an introduction to the subject matter of the present patent application. It is not intended to provide an exclusive or exhaustive explanation. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an illustrative facility management system;

FIG. 2 is a table of user and charge station types, and associated limits applied in an illustrative example;

FIGS. 3A-3B show an illustrative example in block flow form; and

FIG. 4 shows an overall system process in block form.

### DETAILED DESCRIPTION

In an illustrative example, a facility management system is configured to reduce (derate) power supplied to electric vehicle charging stations that obtain power from the facility. A charge station (CS) supervisor performs such tasks. As used herein, the CS supervisor may be a separate controller from a facility controller, or may be integrated into a single controller structure or cluster with the rest of the facility management system.

In examples, the EV users and charging stations are categorized, including normal or premium EV users, and normal or reservable charge stations. Some of the EV users are subject to limiting use criteria, in particular, normal EV users may be subject to limited duration of charging sessions and/or limited power quantities during charging sessions. In some examples, these limitations do not apply to the premium EV users.

In further examples, the facility management system determines whether a reduction in power to the charging stations is desired. The need for and quantity of reduction is performed by a facility manager, which can be a controller, but may be also done with human intervention. This may occur due to any reason, though some examples include heavy power usage in the system and/or at the charging stations, and/or due to possible inability of the facility to obtain power in a desired manner (such as high costs, grid alert, potential blackout/grid instability, unavailability or low power from local or renewable systems, etc.). Tiered grid pricing, for example, may play a role, as well as any communications of potential grid instability from the provider of grid power.

In response to the determination of a reduction in power to the charging stations, the CS supervisor uses the classifications to determine reductions to the power supplied to the charging stations. Specifically, criteria including priority applied to the individual EVs at the charging stations (where first priority may apply to those EVs at the highest state-of-charge (SOC), for example); priority criteria may be optional.

Next, load reductions are determined by the CS supervisor for one or more of the charge stations. A maximum load reduction and a setback are both defined. Normal users at normal charging stations are subjected to the maximum load reduction, while normal users at reservable charging stations, and premium users at normal charge stations are subjected to the maximum load reduction less the setback. Finally, premium users at reservable charging stations are not subject to reduction. Further detailed examples follow.

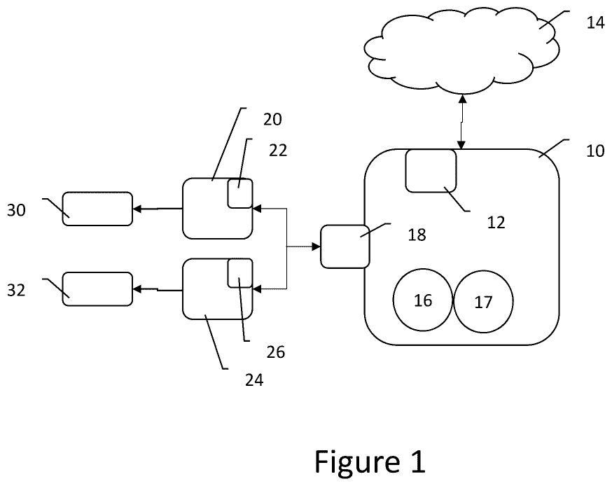

FIG. 1 shows an illustrative facility management system with EV charging stations. The facility 10 has a facility management system 12, which may be operable in cooperation with one or more cloud resources 14, such as stored databases, prediction models, analysis modules and various serves. The cloud resources 14 may, for example, provide preview of anticipated power need or power pricing, for example, using data from grid power suppliers and/or weather monitoring (or other data sources) to determine or predict costs of grid electricity and/or to predict demands from power users or sources, for example, a power user 16 in the facility (such as heating/ventilation/air conditioning (HVAC) system) and/or a power source 17 (such as a wind or solar power generator).

The facility 10 is associated with electric vehicle (EV) charging stations (CS) at 20, 24, each having a CS controller 22, 26. The CS 20, 24 are configured for charging vehicles 30, 32, which may be pure electric vehicles or plug-in-hybrid vehicles (using fuel cells, internal combustion engines, etc.), as desired. Power to each CS is routed through the facility 10, making such CS power subject to facility management.

Within the proposed system, some users or EVs may be categorized as premium, or normal. For purposes herein, a premium EV or normal EV refers to whether the user of the EV (driver, occupant (such as if the EV is an autonomous vehicle), owner, etc.) has subscribed or paid for Premium status. The CS 20, 24 may also be categorized as reservable or normal. A reservable CS means a CS that can be reserved by a user in advance, thus following a schedule of users throughout the day. A normal CS may operate on a first-come, first serve basis. A CS supervisor is shown at 18, and has responsibility for monitoring CS functions and allocating power among the CS 20, 24. Additional categories for users and/or charge stations may be used, if desired.

The facility management system 12 as well as the CS supervisor 18 may include or be implemented as one or more controller systems with associated memory and communication devices. Such controller systems may take many forms, including, for example, a microcontroller or microprocessor, coupled to a memory storing readable instructions for performing methods as described herein, as well as providing configuration of the controller for the various examples that follow. A controller may include one more application-specific integrated circuits (ASIC) to provide additional or specialized functionality, such as, without limitation a signal processing ASIC that can filter received signals from one or more sensors using digital filtering techniques. Logic circuitry, state machines, and discrete or integrated circuit components may be included as well. The skilled person will recognize many different hardware implementations are available for a controller.

The facility management system 12, having a controller as just described, is configured or coupled to devices that can be used to control power supplied to the CS systems. This may include communicating an available power setpoint to each CS from the CS supervisor 18. For example, some existing CS configurations communicate on OCPP (Open Charge Point Protocol) with OCPP servers. Each CS will expose certain read and write parameters with OCPP server, one of such is a SmartChargingProfile. The OCPP server can write a Power or Current Limit to be applied to the Charging Station, so that Power delivery from Charge station to EV can be limited to the value set. An OCPP server can be located either in an on-premises facility controller or in the cloud; based on the configurations and situations of power demand; new limits will be applied to Charge station. For example, the CS supervisor may incorporate or embody one or more OCPP servers which in turn provide a communications interface with each CS. Thus, for example, each CS can be provided with current or voltage, or total utilization setpoints, in various examples, which each CS is allowed to use for a vehicle charging at the CS in illustrative examples. Such power limitations are communicated by the CS supervisor 18.

The CS supervisor 18, facility management system 12 and/or cloud resources 14 may maintain data regarding power demand by each CS 20, 24 and/or collectively needed by the plurality of CS. For example, historical (such as daily) power demand patterns may be stored. Predictions of upcoming load may also be had by, for example, using other systems including access management. For example, if drivers must access the CS through one or more gates or other access controls, the indication of drivers/vehicles present at the facility may be known, allowing an estimation of CS power demand to be generated. As a vehicle enters the facility, a wireless connection to the vehicle may be enabled to allow vehicle need for CS resources to be estimated, such as by the vehicle reporting battery state of charge (SOC), in some examples. In addition, when an EV is connected to a CS using a physical power connector, a communication channel is established between the EV and the CS, and parameters including SOC and data related to charging ability (battery size, chemistry, ideal charging profile or other information as needed) can also be exchanged directly to the CS. Such data may be used to model, estimate or predict potential power demand at the CS system.

The facility management system 12 and/or cloud resources 14 may also maintain data regarding patterns of past power usage by the users 16 in the facility. For example, power usage of a manufacturing line (which can be one of the users 16) may be modeled or estimated by knowing planned use during a given time period and the amount of power typically consumed by such planned use, or knowing historical patterns of power use. If a power user 16 is the HVAC system, current and/or predicted environmental conditions (temperature, humidity, wind, cloud, etc.) may be used to estimate HVAC system power needs. Power demand within the facility 10 can thus be predicted, modeled or estimated.

The facility management system 12 and/or cloud resources 14 may store data and/or obtain data allowing capabilities of power sources 17 to be estimated, modeled, etc. For example, if solar or wind power sources 17 are present, likely power provided by such systems can be predicted using previous patterns as well as weather predictions. The power sources 17 can also be non-renewable (gas power generators), and characteristics (availability and/or price) of grid power or non-renewable power resources (gas for example) may be obtained. The power sources 17 may also include, for example and without limitation, replenishable power sources such as rechargeable batteries and/or gravity-based power storage systems, and data related to the available power from each can also be maintained. Power availability and price points of power can thus be predicted, modeled or estimated for the facility 10.

These inputs, including power demand, power availability, and price points can be used by the facilities manager to determine whether and by how much power used by a plurality of CS on site should be limited. For example, power demand from the facility is monitored; with the addition of EV's to the facility the power demand will increase and it will cause surges in power demand. Often facilities will have contracts with utility providers stating peak power demands, and if the facility power demand exceeds the contractual limit, penalties are enforced. The facility manager monitors power in the facility and can use the methods herein to EV charging station loads to prevent exceeding such power demand limits. As noted above, historical trend and/or other predictive data may be used in power prediction models to estimate the power required and adjust the limits applied to CS usage, in a predictive sense. In other approaches, a maximum power demand threshold for the facility can be set, leaving some buffer relative to a contractual (or otherwise enforced) maximum power demand, and if the real time power demand crosses the threshold, the facilities manager will enforce power derating relative to the CS on side via the supervisor 18.

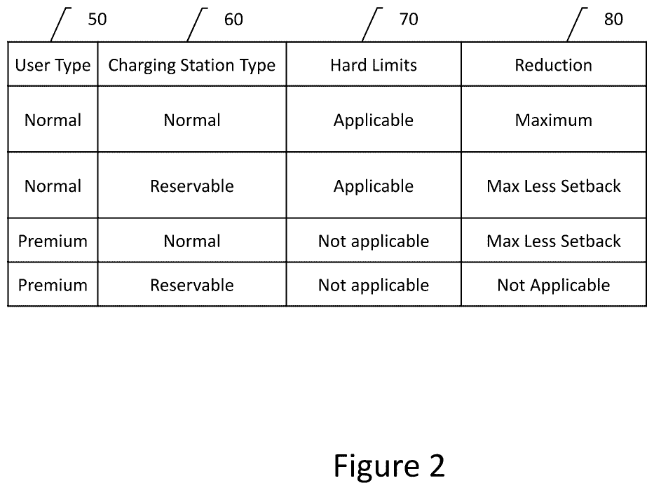

FIG. 2 is a table showing how the system can apply certain limits and parameter changes to users and charging stations by type. At column 50, the user types of normal and premium are identified, and a column 60, the CS types of normal and reservable are identified. Hard limits are applied by the system to normal user types to prevent system overuse by such users (and/or to encourage users with higher EV charging needs to pay for a premium service). Hard limits may, for example, limit any of the maximum time that an EV may be charged at a given CS, the maximum current or power levels to be delivered during charging to an EV at a given CS, or the total energy to be delivered to an EV during a charge session. More than one limit may be applied, for example, charging may be allowed for a fixed period of time (i.e. up to 15 to 30 minutes, depending on configuration), with a maximum current flow during such charging, for example.

In some examples, the hard limits are applied to normal users, but not to premium users. In some examples, premium users are also subject to hard limits, but there may be a “Normal Limit” and a “Premium Limit,” where the Premium Limit allows for greater utilization than the “Normal Limit”. For example, the Normal Limit may be 20 minutes charging, and the Premium Limit may be 30 minutes charging, or, alternatively, maximum current or power may be defined differently for each of Normal and Premium Limits. The configurations applied in the hard limits column 70 may be selected and set by the facilities management system (block 12 in FIG. 1), rather than by the CS supervisor and/or the individual CS controllers 22, 26, as contrasted with prior art systems in which the CS controllers 22, 26 set such limits themselves. For those users not subject to the hard limits—that is, premium users in this example, the user, the CS controller, or the vehicle hardware may determine the parameters used during charging, including levels of power or current and any other variables. Those skilled in the art will be aware of various protocols for EV charging.

As shown, the hard limits column 70 is dependent on user type. Rather than “Applicable” and “Not Applicable,” column 70 may instead refer to “Normal Limits” and “Premium Limits” where premium limits allow higher utilization. Column 80 indicates derating or usage reduction applicability. Here, the facility manager is allowed to instruct the CS supervisor to configure the set of CS controllers to each apply different derating factors to the power supplied during charging. The greatest degree of derating applies to the normal users at normal CS, as indicated. The “Maximum” derating setting is set by the facility manager, and may be, for example, a derating of 0 to 50%, applied to maximum voltage or current, maximum (instantaneous) power, maximum average (RMS for example) current, voltage or power, total delivered energy, etc. The normal user at a reservable CS, or a premium user at a normal CS, may receive derating using the maximum level less a setback amount. For example, if the maximum derating is 30%, the setback may be 20%, yielding a derating of 10% of requested power. Finally, the premium user at a premium charging station may not have any reduction applied. As a result, power made available at the CS is derated in accordance with user/vehicle type (normal/premium) as well as CS type (normal/reservable).

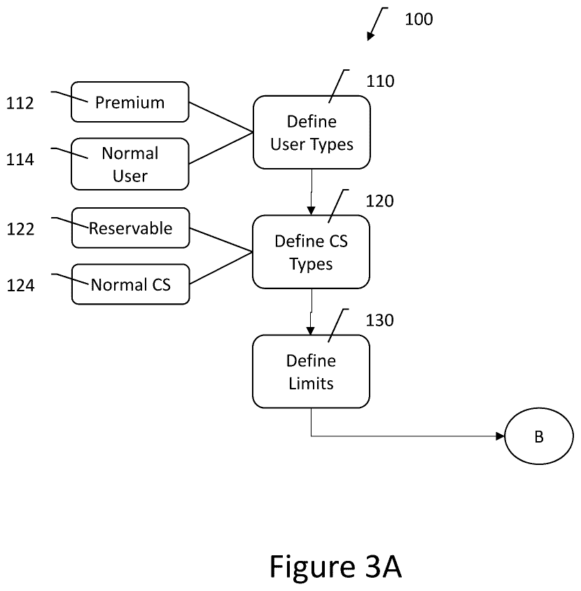

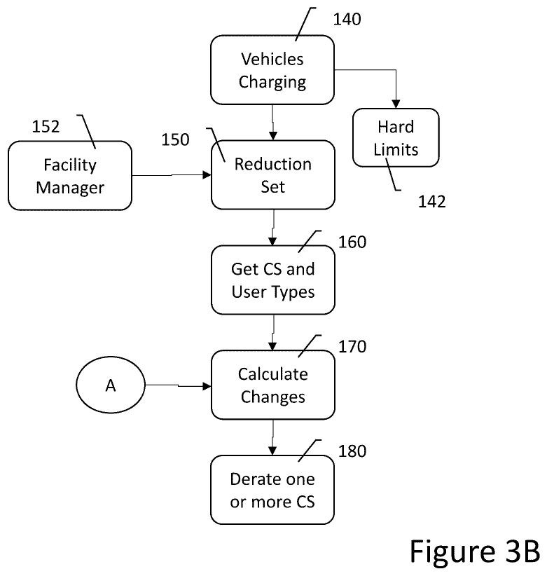

FIGS. 3A-3B is a block flow diagram for an illustrative method or process. FIG. 3A shows a set-up process at 100. User types are defined, as indicated at 110; in an example, two user types are defined as Premium 112 and Normal User 114. More than two user types can be defined, if desired. CS types are defined at 120; in an example, two CS types are defined as Reservable 122 and Normal CS 124. More than two CS types can be defined. The limits applicable within the system are then defined at 130. These may include, for example, hard limits generally applicable to some or all users (column 70 of FIG. 2, for example but without limitation). Reduction or derating settings can also be configured at block 130 (column 80 of FIG. 2, for example but without limitation).

The configuration 100 is then used as shown in FIG. 3B, which illustrates how the CS supervisor can manage CS usage. In the system, a plurality of vehicles are charging at a plurality of CS, as noted at 140. For some users, hard limits 142 apply. When hard limits 142 are reached, either the available power is capped, or a CS may turn off and indicate to the EV (and EV user) that the hard limit has been reached (maximum energy has been delivered, or a time limit reached, for example). The EV user is then obligated to remove the vehicle from the charging station to allow another EV user to charge their vehicle. Such hard limits apply to select users and/or CS at all times, in an illustrative example. As noted, different hard limits may apply to different user and/or CS types.

The facility manager, identifying a potential shortage of available power, or high grid energy pricing, for example, may determine that a reduction of CS total power is desired. A reduction is set at 150, and made applicable to the CS systems associated with the facility by communication from the facility manager 152 to the CS supervisor. At block 150, the facility manager provides both an indication that power reduction to the CS will take place, and also the amount of such reduction. The reduction set at 150 may be chosen by the facility manager via the facility management system, as by human interaction. In other examples, the facility management system and/or cloud resources may use software configured to automatically identify a need for reduction and set the reduction amount 150.

For example, step 150 may be performed by the facility management system predicting, modelling, estimating or measuring power usage and power availability. As previously described, facility power demands can be predicted, modeled, or estimated using various inputs. Power available to the facility, as well as costs of such power, can also be predicted, modeled or estimated using various inputs as previously described. In some examples, current power load of the CS is simply obtained by monitoring all the CS systems present. In other examples, CS power needs/demands can be queried by requesting each CS to indicate a planned charging protocol for an EV at the CS. In a particular example, the step of identifying a need for power reduction may compare the predicted cost of total power to the facility (including CS power) to one or more thresholds at a given time, or as predicted over an upcoming time interval; if the threshold is exceeded, the CS power is derated by a percentage or other unit measurement so that the predicted total cost is reduced, for example, to the desired threshold or average cost. In another example, total power available at the facility is determined and/or predicted, and compared to current or predicted total power needs (including CS power), and, if the total power needs exceed the total power available (including, optionally a buffer as desired), CS power is derated until power available exceeds power needs (again, optionally including a buffer).

The method then obtains the CS and user types 160. Using the limits from 130 and the CS and user types obtained at 160, as well as the desired reduction, and the existing power levels being used, changes to be made to power use at each CS are calculated at 170. Those changes are then implemented at 180 by derating one or more CS systems.

The calculations at 170 can take various forms. In an illustrative example, the starting point goes back to the current state of the CS systems and vehicles at block 140. Illustratively, given vehicles at CS ports 1 to 5, the states shown in Table 1 may be determined:

TABLE 1

| Port | Reservable | User Type | Used Power | SoC | Priority |
|---|---|---|---|---|---|
| 1 | Reservable | Normal | 20 | 80 | 1 |
| 2 | Normal | Premium | 15 | 75 | 2 |
| 3 | Normal | Normal | 20 | 60 | 3 |
| 4 | Normal | Normal | 7 | 40 | 4 |
| 5 | Normal | Normal | 11 | 20 | 5 |
| | Sum | | 73 | | |

Where the power numbers are in kilo-watts, though other units may be used as desired. Table 1 reflects a numerical example shown for illustrative purposes, and is not limiting. The priority lines up with the ports in the illustration but the two are not related. Priority is in this example determined by time, as the vehicle that has been charging the longest has the highest priority, 1, with the vehicle that has had the least time charging is the lowest priority, here, priority 5. Priority may alternatively be determined by the amount of energy delivered to each vehicle, with the vehicle having already received the most power being deemed of highest priority. Priority may instead or also be determined from SOC, for example, applying highest priority to a vehicle having the highest SOC. In the example, the priority is used to determine which vehicle is analyzed first in the derating procedure.

If any CS has a premium user at a reservable port, that port is ignored in the subsequent calculations (at least until the user changes), as was previously noted in FIG. 2; some examples may vary in this regard. As noted above, the configuration also sets a maximum derating, which may be a percentage or a maximum in terms of a desired unit, such as kilowatts. In this numerical example, the maximum derating is set by the facility manager to 30%. Further, a load limit setback is determined for the system, and is set for this example at 20%. The load limit setback is used to reduce the derating applied to premium users at normal ports, and to normal users at reservable ports.

In the example, at a given point in time, the facility manager determines a need for derating CS power use, and determines the quantity of reduction to be 20%, or 14.6 kW using the numbers in the above table (73 kW times 20%). This may be a human-interaction, or may be an automated determination, and may account for any of actual limits, pricing, predictions, modeling, etc., as various discussed above. In other examples, the facility manager may set an available CS power, such that the “reduction” is the difference between the power defined by the facility manager as available, and that which the CS would cumulatively use if not limited.

The calculation then starts with the top priority port/vehicle, here, Port 1. The derating target is 20%, and the maximum derating is set to 30%. However, Port 1 is reservable. This means that the setback is used. In the example, derating for a normal vehicle at a reservable port is calculated as follows:

$$Derating \% = ( Derating\_Max - Setback ) = ( 30 \% - 20 \% ) = 10 \%$$

The percentage derating is thus 10% at port 1, and so the applicable derating is:

$$Derating = Power * Derating \% *= 20 kW * 10 \% = 2 kW$$

A remaining reduction (Red_Rem in the tables below) needed is calculated as derating for each port is calculated. Using the above numerical example, for the first priority, the remaining reduction needed is 14.6 kW, which is greater than 2 kW. Thus the new power for port 1 is calculated as:

$$Power\_New = Power - Derating = 20 kW - 2 kW = 18 kW$$

The analysis continues for each subsequent port based on priority. When a non-reservable port is used by a premium user, (as in Port 2) the calculation is the same as for a normal user at a reservable port, as just shown, in some examples. If desired, there may be separate limits or calculations for each type, such as by defining a different setback for premium users at non-reservable ports, as opposed to normal users at reservable ports. If a normal user is at a non-reservable port, however, the setback is zero, and so the Derating % variable at that port is simply Derating_Max. The process continues in an order determined by the priority until all ports have been re-analyzed, or until the desired reduction is met. Table 2 table shows the calculation of Power_New for each port in the above numerical example:

TABLE 2

| Port | Type | Power | Priority | Red_Rem | Reduction | Power_New |
|---|---|---|---|---|---|---|
| 1 | R/N | 20.0 | 1 | 114.6 | 2.0 | 18.0 |
| 2 | N/P | 15.0 | 2 | 12.6 | 1.5 | 13.5 |
| 3 | N/N | 20.0 | 3 | 11.1 | 6.0 | 14.0 |
| 4 | N/N | 7.0 | 4 | 5.1 | 2.1 | 4.9 |
| 5 | N/N | 11.0 | 5 | 3.0 | 3.0 ** | 8.0 |
| | Sum | 73.0 | | 0.0 | 14.6 | 58.4 |

The double asterisk (**) for the reduction at port 5 reflects the fact that, for port 5, the calculated reduction would have been 3.3 kW (that is, 11.0 kW times 30%), however, the required remaining reduction request was only 3.0 kW, so the lesser value is used. If there were a sixth port having a lower priority, that port would not be subject to reduced power in the numerical example, since the first five ports met the requested reduction. By using priority first, users who have already benefitted (if priority is based on duration of charging, or power/charge delivered), or who have least need (if priority is based on SOC) are affected the most by the power reduction, while users who have received less charging time or power/charge, or greater need are less affected.

If, at the end of the calculations, the requested total power reduction is not yet met, an alert may be generated to notify the facility management system that the requested derating could not be achieved. The facilities manager may, for example, modify any of the parameters as needed, such as by increasing the maximum power reduction, or reducing the setback, if desired. Other changes may be made as well, such as the facilities manager determining that premium users at reservable CS will also be subject to power derating, if desired.

The facilities manager may periodically (at fixed interval) or occasionally (in response to an event) determine to change any of the applied factors used by the CS supervisor to calculate and distribute the power reductions. In some examples, such reconfiguration may be less frequent than adjustments to requested power derating. It should be noted as well that the above discussed hard limits will continue to apply as the derating is applied. Thus, for example, recalculation at the CS supervisor of how the requested reduction is applied or distributed to each CS may be performed if a user reaches an applicable hard limit.

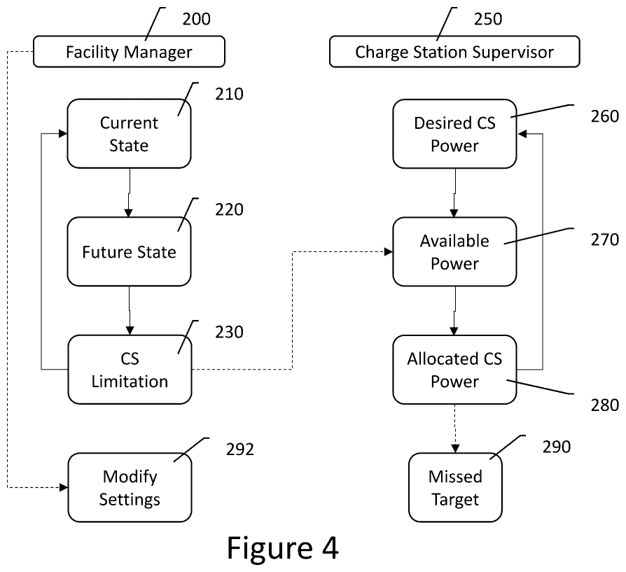

After the method has been performed once, subsequent iterations may replace the current power or prior power used in the above with a calculated value, for example, obtained from each CS by the CS supervisor. FIG. 4 illustrates a process flow for an iterative process. The facility manager 200 has the tasks of determining current state of the facility 210, and, optionally, future state of the facility at 220, to determine what, if any, limitations to apply to CS power usage. For example, current state 210 may determine how much power is being used by various systems in the facility, whether those systems are for manufacturing or other processes, HVAC, etc. The current state 210 may also include capacity of any internal power generators, such as solar panels. Pricing of grid power may also be considered as part of the current state 210. The future state 220 may include any suitable foreseeable changes in power utilization, available power from on-site resources, and/or pricing information. This information is used by the facility manager in any suitable way to determine any limitations to apply to CS power use. Future state 220 may also consider effect of current actions on the future state if, for example, a replenishable power source (rechargeable large-scale battery sources or gravity-based power storage, for example) is used to augment power in the facility.

In a specific example, tiered power pricing may be in effect for grid power and/or peak power penalties may apply. The analysis at the facility manager may seek to avoid drawing grid power in relatively higher tiers of the pricing structure. The state of current state power users and on-site power generators is used to determine how much power can be used by the CS before the higher tier pricing structure is reached, and limitations on the CS power use can therefore be determined. The future state 220 may consider, at least, an upcoming time period before the analysis of the facility manager 200 is iterated. For example, the analysis at 210, 220, 230 may occur every 5, 10 or 15 minutes (longer or shorter intervals can be used), and the future state 220 may consider changes likely during such a time period. A future state 220 may also consider any onsite power resource limitations, for example, if a replenishable power source, such as a rechargeable battery or gravity-based power source is on-site, that power source may be relied upon throughout the day to augment available power, and is recharged overnight, for example, and so the future state 220 may predict power demand throughout the day to prevent overuse of the replenishable power supply early in the day. Such predictions may use inputs such as weather conditions, and/or may be modeled on stored use patterns from previous time periods. These are merely examples, and are provided to allow an understanding of how and why a reduction in power to the CS may occur.

At the charge station supervisor 250, a different analysis takes place. It should be noted that charge station behavior can be quite variable. For example, so-called fast charging schemes may use stepped DC battery charging methods, in which a high constant current is applied for a first period of time to charge the EV battery, then an intermediate current for a second period of time, with two or more such steps leading to a final charge period in which a constant voltage output is delivered. Such schemes are used to limit adverse effects (such as lithium plating) on the EV battery during fast charging while minimizing charging duration. The result is that the power demand of each CS can vary over time, and such variations may occur asynchronous to changes to available CS power made by the facility manager.

The CS supervisor may use an iterative method at a relatively short interval, such as in the range of about 15 seconds to about five minutes. For example, at one minute intervals, the charge station supervisor may query each CS as to the desired CS power at that CS, as indicated at 260. The reported value may be independent of any limitations imposed by the facility manager, and is an “ideal” value. In view of available power to the plurality of on-site CS as a group, as indicated at 270 (which can be controlled by the facility manager as indicated by the broken line from 230 to 270), an allocation of the available CS power is then determined at block 280. Rather than using fixed time intervals, the CS supervisor may operate on an interrupt basis, in which interrupts are generated when a change in CS power at any of the CS ports occurs, for example, causing the CS supervisor to recalculate the distribution of power.

As the CS supervisor 250 iterates its method repeatedly, optimized use of the available power can be achieved. For example, if a premium user at a reservable CS has available all power demanded, that user may be able to charge their EV using a quick-charging scheme at a first CS. When the user at the first CS reaches a particular point in the charging process, the current used by the first CS will step down, according to the specifics of the fast-charging protocol. As the power used by the first CS drops, the available power based on any applied CS limitation from block 230 remains unchanged, as there is nothing to synchronize the facility manager's decisions with the CS operation. As a result, the CS supervisor can then reallocate available power to other CS users.

For example, using a similar chart to the above, assume that 75 power units (which may be kW as in prior examples, but can be any suitable power unit, current unit, etc.) are made available to the CS, at time t1, as a reduction from a prior power level of 84 power units. Table 3 shows how the CS supervisor may allocate power in an illustrative example:

TABLE 3
@ t1

| | | Power | | | | |
|---|---|---|---|---|---|---|
| Port | Type | Request | Priority | Red_Rem | Reduction | Power_New |
| 1 | R/P | 20.0 | n/a | 9.0 | 0 | 20.0 |
| 2 | N/P | 15.0 | 1 | 7.5 | 1.5 | 13.5 |
| 3 | R/N | 20.0 | 2 | 5.0 | 2.5 | 17.5 |
| 4 | N/N | 14.0 | 3 | 0.8 | 4.2 | 9.8 |
| 5 | N/N | 15.0 | 4 | 0.0 | 0.8 ** | 14.2 |
| | Sum | 84.0 | | 0.0 | | 75.0 |

| | | |
|---|---|---|
| Less R/P | 64.0 | 55.0 |

Here, because port 1 uses 20.0 units of power, and is both a reservable CS and has a premium user, the power to port 1 is not derated. The CS Supervisor does not include port 1 in the calculations except to reduce the available power to the remaining stations. That is, 64.0 units (84.0 minus 20.0) of power are requested at ports subject to the derating, and there are 55.0 units (75.0 minus 20.0) of power available. The total reduction is thus 9 units of power. That reduction may be allocated as shown in Table 3, at time t1, as follows. First, the highest priority port is Port 2. Assuming a 30% maximum derating and a 20% setback, at 10% reduction applies to the users in port 2 and port 3, resulting in 1.5 unit and 2.5 unit reductions, for 4.0 units total. Using the 30% maximum for port 4 yields a 4.2 unit reduction, and the remaining 0.8 units needed to derate CS usage is taken at port 5.

Supposing then that the power request changes at one of the ports at time t2:

TABLE 4
@ t2

| | | Power | | | | |
|---|---|---|---|---|---|---|
| Port | Type | Request | Priority | Red_Rem | Reduction | Power_New |
| 1 | R/P | 15.0 | n/a | 4.0 | 0 | 15.0 |
| 2 | N/P | 15.0 | 1 | 2.5 | 1.5 | 13.5 |
| 3 | R/N | 20.0 | 2 | 0.0 | 2.5 | 17.5 |
| 4 | N/N | 14.0 | 3 | 0.0 | 0.0 ** | 14.0 |
| 5 | N/N | 15.0 | 4 | 0.0 | 0.0 ** | 15.0 |
| | Sum | 79.0 | | 0.0 | | 75.0 |

| | | |
|---|---|---|
| Less R/P | 64.0 | 60.0 |

Here, the EV charging protocol has reduced power demand at port 1 by 5 units, but no other changes occur. Thus the new total power request is 79 units, and the requested reduction is now only 4 units to get to the available 75 units. Power used at ports 4 and 5 is allowed to increase to meet the full power request, thereby adjusting for the change at port 1.

Because the system uses several settings that can each vary, and system utilization at the set of CS can also vary, it may be that a requested reduction in power use cannot be achieved at a given point in time. This may occur, in particular, if there are premium users at reservable CS ports whose use is not reduced in the preceding examples. Several possible solutions are available.

In the example of FIG. 4, if the reduction goal cannot be achieved, as indicated at 290, a communication is generated by the CS supervisor 250 to the facility manager 200, which the facility manager may use as a prompt to adjust one or more settings. For example, the maximum reduction applicable to vehicles can be increased (in the above numerical example, 30% maximum reduction could be increased to 35%, for example), or the setback can be reduced (in the above numerical example, the 20% setback could be reduced to 15%, for example). In still further examples, particularly in extreme circumstances, the facility manager may be allowed to implement (at least temporarily) reductions applicable to the premium users at reservable CS ports. Thus a premium user at a reservable CS port may be treated the same as a normal user at a reservable port, in the temporary situation to reduce CS power draw. When doing so, the system may be further configured to apply the lowest priority to the premium user at reservable CS, thereby making that user less affected than other users. This is just an example.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic or optical disks, magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, innovative subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the protection should be determined with reference to the appended claims, along with the full scope of equivalents to which such claims are entitled.

What is claimed is:

1. A facility management system for a facility having one or more internal power users and at least two charging stations each adapted for charging electric vehicles using charging station (CS) power controlled by the facility management system, the two charging stations each classified as either a first CS type or a second CS type, the electric vehicles each classified as either a first user type or a second user type, the facility comprising at least one non-charging station power user, the facility management system including a CS supervisor configured to:
deliver power to a first charging station to charge a first electric vehicle;
determine the user type for the first electric vehicle and the charge station type for the first charging station; and:
if the first electric vehicle is the first user type, monitor at least one of duration of charging relative to a duration threshold, or a power delivered during charging relative to a power threshold, and, upon reaching the duration threshold or the power threshold, the CS supervisor is configured to instruct or cause the first charging station to stop charging the first electric vehicle; and
otherwise, the CS supervisor is configured to allow the first electric vehicle, the first charging station, and/or a user of the first electric vehicle to determine when to stop charging the first electric vehicle.

2. The facility management system of claim 1, wherein the CS supervisor is configured to:
receive an input indicating CS power to the at least two charging stations is to be reduced by a reduction amount;
determine, for each electric vehicle at each charging station, a user type and a CS type, and a first CS power used at each charging station;
calculate a second CS power for each charging station based on each of the first CS power, the reduction amount, the user type, and the CS type; and
derate power delivered to at least one of the charging stations using the calculated second CS powers such that total power to the at least two charging stations is reduced by the reduction amount.

3. The facility management system of claim 2, further comprising a facility controller which is configured to provide the input indicating CS power to the CS supervisor by:
observing a current state of the facility, including power used in the facility; and
determine a quantity of power reduction applicable to the CS power required from the CS supervisor.

4. The facility management system of claim 2, wherein the CS supervisor is configured to:
receive a maximum derating value, and a setback derating value;
calculate the second CS power for each charging station as follows:
determining a priority of the electric vehicles from 1 to n, wherein n is the number of electric vehicles at charge stations when the calculation is performed and the priority ranks the electric vehicles according to predetermined criteria;
starting with the vehicle of the highest priority, calculating a load change and proceeding until a sum of calculated load changes equals the reduction amount, as follows:
for a user of the first user type and a charge station of the first CS type, multiplying the first CS power by the maximum derating value to calculate the load change;
for a user of the second user type and a charge station of the first CS type, multiplying the first CS power by a difference between the maximum derating value and the setback derating value to calculate the load change;
for a user of the first user type and a charge station of the second CS type, multiplying the first CS power by a difference between the maximum derating value and the setback derating value to calculate the load change;
for a user of the second user type and a charge station of the second CS type, setting the load change to zero; and
calculating the second CS power equal to the first CS power minus the load change.

5. The facility management system of claim 4, wherein the priority ranks the electric vehicles from a highest state of charge (SOC) to lowest SOC.

6. The facility management system of claim 4, wherein the priority ranks the electric vehicles from a longest duration of charging to a shortest duration of charging.

7. The facility management system of claim 4, wherein the priority ranks the electric vehicles from a largest quantity of power delivered during charging to a least quantity of power delivered during charging.

8. The facility management system of claim 1, wherein the first CS type is a normal charge station, and the second CS type is a reservable charge station, and the first user type is a normal user, and the second user type is a premium user type.

9. A facility management system for a facility having one or more internal power users and at least two charging stations each adapted for charging electric vehicles using charging station (CS) power controlled by the facility management system, the two charging stations each classified as either a first CS type or a second CS type, the electric vehicles each classified as either a first user type or a second user type, the facility management system comprising at least one non-charging station power user, comprising a CS supervisor configured to:
receive an input indicating CS power to the at least two charging stations is to be reduced by a reduction amount;
determine, for each electric vehicle at each charging station, a user type and a CS type, and a first CS power used at each charging station;
calculate a second CS power for each charging station based on each of the first CS power, the reduction amount, the user type, and the CS type; and
derate power delivered to at least one of the charging stations using the calculated second CS powers such that total power to the at least two charging stations is reduced by the reduction amount.

10. The facility management system of claim 9, further comprising a facility controller which is configured to provide the input indicating CS power to the CS supervisor by:
observing a current state of the facility, including power used in the facility; and
determine a quantity of power reduction applicable to the CS power required from the CS supervisor.

11. The facility management system of claim 9, wherein the first CS power for each charging station is determined as an actual power used at each charging station.

12. The facility management system of claim 9, wherein the first CS power for each charging station is calculated as a power request for each charging station.

13. The facility management system of claim 9, wherein the CS supervisor is configured to:
receive a maximum derating value, and a setback derating value;
calculate the second CS power for each charging station as follows:
determining a priority of the electric vehicles from 1 to n, wherein n is the number of electric vehicles at charge stations when the calculation is performed and the priority ranks the electric vehicles according to predetermined criteria;
starting with the vehicle of the highest priority, calculating a load change and proceeding until a sum of calculated load changes equals the reduction amount, as follows:
for a user of the first user type and a charge station of the first CS type, multiplying the first CS power by the maximum derating value to calculate the load change;
for a user of the second user type and a charge station of the first CS type, multiplying the first CS power by a difference between the maximum derating value and the setback derating value to calculate the load change;
for a user of the first user type and a charge station of the second CS type, multiplying the first CS power by a difference between the maximum derating value and the setback derating value to calculate the load change;
for a user of the second user type and a charge station of the second CS type, setting the load change to zero; and
calculating the second CS power equal to the first CS power minus the load change.

14. The facility management system of claim 13, wherein the priority ranks the electric vehicles from a highest state of charge (SOC) to lowest SOC.

15. The facility management system of claim 13, wherein the priority ranks the electric vehicles from a longest duration of charging to a shortest duration of charging.

16. The facility management system of claim 13, wherein the priority ranks the electric vehicles from a largest quantity of power delivered during charging to a least quantity of power delivered during charging.

17. The facility management system of claim 9, wherein the first CS type is a normal charge station, and the second CS type is a reservable charge station, the first user type is a normal user, and the second user type is a premium user type.

18. The facility management system of claim 9, wherein the CS supervisor is configured to calculate a second CS power for each charging station by determining a priority of the electric vehicles from 1 to n, wherein n is the number of electric vehicles at charge stations when the calculation is performed and the priority ranks the electric vehicles according to predetermined criteria.

19. The facility management system of claim 9, wherein the CS supervisor is configured to derate the power delivered to the at least two charging stations by communicating a maximum allowed power to each of the at least two charging stations.

20. A method of managing power delivered to a plurality of charging stations (CS) at a facility comprising:
receiving an input indicating CS power to the plurality of CS is to be reduced by a reduction amount;
determining, for each electric vehicle at each CS, a user type and a CS type, and a first CS power used at each CS;
calculating a second CS power for each CS based on each of the first CS power, the reduction amount, the user type, and the CS type; and
derating power delivered to at least one of the CS using the calculated second CS powers such that total power to the plurality of CS is reduced by the reduction amount.
